(19) United States
(12) Patent Application Publication
(10) Pub. No.: US 2020/0047435 A1
(43) Pub. Date: Feb. 13, 2020

(54) APPARATUS FOR AND METHOD OF FIBRE PLACEMENT FOR THE FORMATION OF FIBRE PREFORMS

(71) Applicant: HEXCEL REINFORCEMENTS UK LIMITED, Duxford, Cambridgeshire (GB)

(72) Inventors: Thomas JAMES, London (GB); Arthur Lewis SWARBRICK, Loughborough (GB); Ian HAYTO, Duxford (GB); Dimitrios KARANATSIS, Duxford (GB); Ian JONES, Duxford (GB); Tim JONES, Duxford (GB); Christopher BEARD, Duxford (GB)

(73) Assignee: HEXCEL REINFORCEMENTS UK LIMITED, Duxford, Cambridgeshire (GB)

(21) Appl. No.: 16/607,040

(22) PCT Filed: Apr. 27, 2018
(86) PCT No.: PCT/EP2018/060992

§ 371 Date: Oct. 21, 2019

(30) Foreign Application Priority Data
Apr. 28, 2017 (GB) 1706868.5

(51) Int. Cl. B29C 70/56; B29B 11/12; B29C 70/38; B29C 70/54; B29C 31/08; B29B 11/16

(52) U.S. Cl. CPC B29C 70/56; B29B 11/12; B29B 11/16; B29C 70/542; B29C 31/08; B29C 70/382

(57) ABSTRACT

A manufacturing apparatus for constructing a 3D preform from carbon fibre tow (10), in which the tow is deposited by an AFP head (2400) onto a membrane (2204) which is conveyed to a forming cell (114) for diaphragm forming. Active tension control is provided with an offwind (102) combined with an accumulator (106) and compensator (108). The invention also provides a method of manufacture.

The present invention is concerned with an apparatus for, and method of fibre placement for formation of a fibre preform in composite manufacture. More specifically, the present invention is concerned with an apparatus for creating a fibre preform for composite component manufacture using automated fibre placement (AFP).

Fibre reinforced composite materials are increasingly used to provide lightweight and strong alternatives to metals. Such materials are common in the aerospace sector and increasing in use in the automotive sector. Carbon composite materials are ideal candidates for steel replacement, capable of equal strength and stiffness at a third of the weight. One method of manufacturing such materials is resin transfer moulding (RTM). This is also the most appropriate technology for high volume vehicle manufacture. The European led TECABS group (Technologies for carbon fibre reinforced modular automotive structures) cite a weight saving potential of 50% over conventional steel body-in-white construction, using RTM or other ways of infusing such as wet pressing to produce a carbon composite intensive vehicle. The potential fuel saving and environmental benefits are significant.

Use of carbon composites has been fairly commonplace in motorsport and niche markets, but adoption of fibre reinforced composites in mass manufacture has been slow. Manufacture of fibre reinforced composites by RTM can be an expensive, labour-intensive and lengthy process.

The known method typically starts with reels of carbon tow. Tow is a bundle of continuous filaments, and the tow may be twisted or untwisted (often referred to as “flat”). The tow is used to fabricate continuous woven or non-woven fibre sheet. Individual layers making up the non-woven sheet are typically stitched to hold them together. Binder may be applied to the sheets. These sheets are typically of constant width and continuous, such that they can be rolled into large rolls for onward transport.

The rolled up sheets are cut to a desired shape and we refer to these shapes as 2D shapes or 2D forms as they consist only of a single layer of the sheet. During this process there is significant waste as the 2D shapes typically do not fill the entire surface of the sheet. Once the 2D forms have been cut from the sheet they are laid on top of one another to form a preform of multiple layers and this preform is therefore referred to as a 3D preform. The binder is then activated (e.g. by heating) to hold the 3D preform in its three dimensional form. The 3D pattern can be removed.

The three dimensional preform is then loaded into a mould tool for resin transfer moulding (RTM). The preform is infiltrated with a liquid polymer matrix material which is then cured under heat and pressure to form a finished part.

EP1473132 discloses a process for producing a preform in which a multiaxial fabric is prepared made of alternating layers of unidirectional fibres. The disclosed process is configured to generate a continuous sheet or roll of material for downstream cutting and forming processes. It therefore exhibits the problems discussed above.

US2009/0120562 discloses a process for forming a continuous multiaxial fabric material for composite manufacture. The material needs to be cut to shape and laid up, thereby exhibiting the problems described above.

There are several problems with this known method in general.

Firstly, the steps of preparing a sheet of carbon fibre material and cutting 2D shapes creates waste carbon fibre material. This is problematic because carbon fibre is very expensive, and difficult to recycle. This makes the process particularly susceptible to increased cost through waste. Waste carbon fibre is also less readily recyclable than e.g. metals.

Secondly, the process is reliant on labour to lay up the 2D preforms onto the 3D pattern. This adds cost to the process, and further can result in errors.

What is required is an apparatus and process of forming fibre reinforced composite components which addresses the above problems.

Automated fibre placement (“AFP”) has been proposed in various fields.

US2016/0001464 discloses a method of constructing a preform by depositing fibre tape onto a flat surface (in this case a conveyor). After deposition, the preform is lifted from the conveyor by a robot arm for a subsequent moulding process. A disadvantage of this process is that the preform needs to have excellent integrity before moulding, else the handling process will tend to deform and disrupt it, which is undesirable. Therefore, there is a need to use a significant amount of binder, which may negatively affect the mechanical properties of the finished article.

Filament winding tools are another example of AFP, although they are suited to parts with closed cross-sections, and are not capable of manufacturing e.g. complex panels for use in the automotive industry.

An alternative method known as tailored fibre placement (TFP) has also been proposed. In this method, the fibre is attached to a base material with a stitching pattern. The fibre is placed in a 3D shape, thus directly creating the preform. This method is problematic because stitching is required for every layer of tow, and the stitching associated with each new layer penetrates the tow in previous layers resulting in poor mechanical properties. Also, because of the base material, the part has to carry a high parasitic weight, which acts against the primary motivation for using fibre reinforced composites in the first place.

It is an aim of the invention to provide an apparatus and method for manufacturing fibre reinforced composite parts which alleviates or overcomes the above problems and/or to provide improvements generally.

### SUMMARY OF THE INVENTIONS

According to the inventions there are provided methods, apparatus and preforms as defined in any of the accompanying claims.

### General Concept

In a first aspect of the invention there is provided a method of manufacture of a preform for a composite moulding manufacturing operation, comprising the steps of:
providing a deformable surface in a first shape;
depositing a fibre onto the flexible membrane to form a preform in a first shape;
deforming the deformable surface and thereby the preform into a second shape different to the first shape.

Advantageously, depositing fibre directly onto a deformable surface such as a (flexible) membrane eliminates the need to separate the preform from the surface onto which it is deposited before moulding. This reduces the risk of damage, and furthermore eliminates the need to provide a structurally self-supporting preform before further deformation/moulding.

Preferably the method comprises the steps of providing a fibre placement head and moving at least one of the fibre placement head and deformable surface relative to one another whilst depositing the fibre from the head onto the deformable surface to form the preform in the first shape. Preferably the head is linearly moveable in at least two axes. The deformable surface may be rotationally moveable relative to one another about an axis intersecting the deformable surface. The combination of Cartesian (XY) movement of the head, and rotation of the surface is advantageous as it allows a robust gantry system to be used to move the head.

Preferably the method includes the step of depositing two or more layers of fibre onto the deformable surface. In this way, a multi-layer preform can be constructed. Rotation of the surface allows a combination of layers of different orientations to be used. Between the steps of depositing each layer, the membrane is rotated such that in a first layer of fibres, the fibres are at a non-zero angle to those in a second, adjacent layer of fibres.

Preferably the method comprises the steps of providing a material configured to bind adjacent layers of fibre material and applying the material to the fibre. The material may be applied before or after deposition of the fibre onto the surface. For example, it may be applied to the fibre continuously before deposition in e.g. a powder binder form. If applied after deposition, it may take a powder form or preferably the form of a sheet—for example a scrim which as well as binding the preform, aids infiltration during subsequent resin transfer. The material may be applied before or after each layer of fibre.

The material may be thermally responsive in which case, the method includes the step of increasing the temperature of the material before or during the step of deforming the fibre to form the preform into the second shape to thereby bind adjacent fibres.

Preferably the method includes the step of providing a membrane assembly, the membrane assembly comprising a membrane defining the surface, supported by a frame. The frame preferably defines an endless loop surrounding an aperture spanned by the membrane. Preferably the membrane is pre-tensioned. This avoids/reduces sag during transit.

Preferably the method comprises the steps of providing a membrane bed having a non-deformable surface and supporting the membrane on the surface of the bed during the step of depositing the fibre. By “non-deformable” we mean significantly stiffer than the membrane, and sufficiently stiff to provide a reaction surface to the operation of fibre deposition.

Preferably the surface of the bed fits inside the frame such that the membrane assembly can be lowered onto the bed to make contact between the membrane and the surface of the bed. This tensions the membrane providing a smooth, continuous surface for fibre deposition.

Preferably the method comprises the steps of providing a further deformable surface and after the step of depositing the fibre, enclosing the deposited fibre between the deformable surface and the further deformable surface to form a fibre cavity, before deforming the fibre to form a 3D preform by deforming the deformable surface and the further deformable surface. The fibre preform is thereby “sandwiched” between the surfaces, which are preferably defined on cooperating membranes.

Preferably the pressure in the fibre cavity is lowered before the step of deforming the fibre. Preferably it is lowered to a pressure where the surfaces both contact the fibre preform across its ensure surface area.

Preferably the method comprises the steps of:
providing a fibre deposition cell at which the step of depositing the fibre takes place;
providing a separate forming cell at which the step of deforming takes place; and,
conveying the deformable surface between the fibre deposition cell and the forming cell.

According to a second aspect of the invention there is provided an apparatus for the manufacture of a fibre preform for a composite moulding operation, the apparatus comprising:
a fibre placement head;
a deformable form;
a three dimensional mould shape;
in which at least one of the fibre placement head and deformable surface is moveable relative to one another to deposit fibres onto the deformable surface to form a preform in a first shape; and,
in which at least one of the deformable surface and three-dimensional mould form is movable relative to the other such that the preform in the first shape on the deformable surface is deformed into a second shape different to the first shape.

The second aspect exhibits the same advantages as the first aspect.

Preferably the fibre placement head is linearly moveable in at least two axes. Preferably the deformable surface is generally planar, and rotationally moveable in its own plane.

Preferably there is provided an application sub-assembly for applying a material configured to bind adjacent layers of fibre to the deposited fibre. The binder material may be applied to the fibre before or after deposition. In the latter case the binder material may be provided from e.g. a roll of binder scrim.

The binder material may be in the form of a film or a sheet or a layer. The binder material may comprise a resin. The binder material may be tacky at room temperature.

Alternatively the material may be in a powder form.

Preferably there is provided an energy source configured to increase the temperature of the material configured to bind adjacent layers of fibre before or during deforming the fibre. In other words, the material is a heat responsive material such as a thermoplastic binder.

Preferably a membrane defines the deformable surface, the membrane supported by a frame. Preferably the membrane is pre-tensioned in the frame.

Preferably the apparatus comprises a bed having a non-deformable surface for supporting the deformable surface during fibre deposition. Preferably the non-deformable surface of the bed fits inside the frame such that the membrane assembly can be lowered onto the bed to make contact between the membrane and the surface of the bed to thereby tension the membrane.

Preferably a further deformable surface is provided and arranged so as to enclose the deposited fibre between it and the deformable surface during deformation of the preform. Preferably a de-pressurisation system (such as a vacuum pump) is configured to lower the pressure between the deformable surface and the further deformable surface before deforming the fibre.

Preferably the apparatus comprises:
a fibre deposition cell comprising the fibre placement head;
a separate forming cell comprising the three-dimensional mould form; and,
a conveyor for conveying the deformable surface between the fibre deposition cell and the forming cell.

### Fibre Tension Control

According to a third aspect of the invention there is provided a method of maintaining fibre tension in a composite manufacture operation, the method comprising the steps of:
providing a fibre supply;
providing a fibre placement head;
moving the fibre placement head relative to the fibre supply;
maintaining a tension in the fibre between the fibre supply and the fibre placement head by actively varying the length of a fibre buffer between the fibre supply and the fibre placement head based on the movement of the fibre placement head.

Advantageously, this permits tension in the fibre to be maintained in a fibre supply from a static supply to a moveable head.

Preferably the method comprises the steps of providing a moveable fibre guide defining part of the fibre buffer and moving the moveable fibre guide to vary the length of the fibre buffer.

Preferably the method comprises the steps of maintaining a tension in the fibre by increasing a compensation force on the fibre upon a decrease in fibre tension, and decreasing the compensation force on the fibre upon an increase in fibre tension. Preferably a resilient compensation force is applied to the fibre, preferably via a resiliently biased fibre guide.

Preferably the compensation force is applied downstream of the fibre buffer, and at a static position (i.e. “off head”). This reduces the mass of the fibre placement head which is advantageous for speed and accuracy of operation.

Preferably the compensation force is applied passively. Therefore the system comprises an active accumulator sub-system which accounts for large, low frequency changes in fibre tension due to movement of the head and a passive compensator sub-system element which accounts for high frequency changes in tension. Both systems work together to maintain a constant, controlled tension in the fibre. By “active” we mean controlled by a controller, and by “passive” we mean not actively controlled—e.g. by a spring or other resilient member or load mass.

Preferably:
the step of providing a fibre supply comprises the step of providing a plurality of fibre feeds;
the step of varying the length of the fibre buffer comprises varying the length of the fibre buffer of the plurality of fibre feeds supplied simultaneously; and,
the step of varying the compensation force on the fibre comprises the step of applying independent compensation forces to each of the plurality of fibre feeds individually.

As the head will deposit the plurality of fibres simultaneously, the system can be made more efficient by allowing the low frequency actively controlled sub-system to act across all fibre tows simultaneously. Smaller, high frequency changes in tension can occur in each fibre feed, or tow, individually and as such it is advantageous to have individual fibre feed compensation. It will be noted that the passive compensator sub-system is less complex and expensive than the active accumulator sub-system, and as such more readily and cheaply reproduced.

According to a fourth aspect of the invention there is provided a fibre tension apparatus for a composite manufacture operation comprising:
a fibre input;
a fibre output configured to feed fibre to a fibre placement head;
a fibre buffer between the fibre input and output;
in which the fibre buffer is configured to actively vary in dependent on movement of a fibre placement head fed from the output to maintain a predetermined tension in the fibre.

Preferably a moveable fibre guide defines part of the fibre buffer. More preferably the moveable fibre guide is positioned between two static fibre guides to create “U” shaped fibre buffer. The height of the “U” can be varied by movement of the moveable guide positioned at the bottom of the “U” (height is used for clarity, regardless of its spatial orientation).

Preferably there is provided comprising a compensator configured to apply a compensation force to the fibre to maintain a predetermined tension in the fibre. Preferably the compensator comprises a resiliently biased fibre guide to apply the compensation force.

Preferably the compensator is downstream of the fibre buffer. Preferably the compensator is static (i.e. off-head).

Preferably the compensator is passive i.e. has no active input during use.

Preferably the apparatus has a controller configured to actively vary the length of the fibre buffer in response to movement of the fibre placement head. Preferably controller controls movement of the fibre placement head and as such can anticipate such movement and control the accumulator at the same time as the head to maintain fibre tension.

### Cutting and Tension Control

According to a fifth aspect there is provided a method of maintaining fibre tension in a composite manufacture operation comprising the steps of:
providing a supply of fibre;
providing a surface for deposition of the fibre;
depositing the fibre onto the surface in a first direction under tension;
cutting the fibre;
maintaining tension in the fibre after the step of cutting by gripping the fibre upstream of the cut.

Advantageously, the present invention allows tension to be maintained whilst cutting the fibre. This avoids slack/bunching of the fibre.

Preferably the step of maintaining tension in the fibre after the step of cutting by gripping the fibre upstream of the cut comprises the step of allowing the fibre to feed in a second direction, opposite to the first direction, whilst gripped. Allowing the fibre to feed in reverse keeps it away from the area of the fibre placement head where the fibre is cut and/or deposited. This is advantageous whilst moving the head to a new position.

Preferably the fibre is gripped between a pair of rolling elements, comprising and there is provided step of controlling the rotation of at least one of the pair of rolling elements.

Preferably, once the head is ready to resume deposition, there is provided the step of feeding the fibre in the first direction. Preferably there is provided the step of using the rolling elements to feed the fibre towards the surface.

According to a sixth aspect of the present invention there is provided a fibre tension apparatus for a composite manufacture operation comprising:
a fibre input;
a fibre output;
a fibre cutter between the input and the output;
a fibre gripping arrangement between the input and the fibre cutter;
in which the apparatus is configured to feed fibre in a first direction, under tension, from the output to be deposited onto a surface;
in which the fibre cutter is configured to cut the fibre; and,
the fibre gripping arrangement is configured to maintain a tension in the fibre by gripping the fibre after cutting.

Preferably the fibre gripping arrangement is configured to feed the fibre in a second direction opposite to the first after cutting.

Preferably the fibre gripping arrangement comprises a pair of rolling elements, in which rotation of at least one of the pair of rolling elements is controlled. Preferably the at least one of the pair of rolling elements is driven by a motor. Preferably the motor is configured to feed the fibre in the first direction to resume deposition of the fibre.

Preferably the motor comprises an output shaft and the at least one of the pair of rolling elements is connected to the motor shaft by a clutch, the clutch configured to:
permit rotation of the at least one of the pair of rolling elements to relative to the output shaft when the fibre moves in the first direction; and,
inhibit rotation of the at least one of the pair of rolling elements to relative to the output shaft when the fibre moves in the second direction.

Advantageously, this allows the fibre to be freely deposited without needing to “pull” the motor shaft, The clutch may be a “sprag” type clutch. The clutch could be substituted by accurately synchronising the speed of the motor to the head's deposition rate.

### Heated Fibres

According to a seventh aspect of the invention there is provided a method of manufacture of a fibre preform for a composite manufacture operation comprising the steps of:
providing a fibre supply;
providing a surface having a thermally responsive material thereon;
increasing the temperature of the fibre; and,
depositing the increased temperature fibre onto the thermally responsive material to form a fibre preform.

Advantageously, this allows the use of a dry fibre tow which can be deposited directly onto e.g. a scrim. This reduces the parasitic weight (compared to traditional powdered tows) and creates a structurally sound preform.

Preferably the step of increasing the temperature of the fibre comprises the steps of providing a heater and heating the fibre with the heater. The heater may be e.g. resistive and in contact with the passing fibre. An e.g. infra-red may be provided in the alternative. The important thing is that energy in some form is imparted to the fibre to raise its temperature before deposition.

Preferably the steps of increasing the temperature of the fibre; and, depositing the increased temperature fibre are carried out on a moveable fibre placement head.

Preferably the step of providing a surface having a thermally responsive material thereon comprises the step of at least partially covering the surface in a sheet of thermally responsive material, or a particulate thermally responsive material. By “thermally responsive” we mean a material which softens and/or melts upon the application of heat, such as a thermoplastic.

The “surface” may be a layer of fibre i.e. the fibre may be deposited in layers with thermoplastic material between each layer to hold the preform together.

According to an eighth aspect of the invention there is provided an apparatus for deposition of a fibre preform for a composite manufacture operation comprising:
a fibre placement head configured to deposit fibre onto a surface; and,
a fibre heating apparatus configured to increase the temperature of the fibre prior to deposition from the fibre placement head.

Preferably the fibre heating apparatus comprises a heated member adjacent a fibre channel. Preferably the heated member is arranged to be in contact with the fibre.

Preferably the fibre heating apparatus is located on the fibre placement head, and in which the fibre placement head is moveable.

The invention also provides a fibre placement system comprising:
an apparatus according to the eighth aspect; and,
a surface for deposition of fibre, which surface has a thermally responsive material thereon.

### SPECIFIC DESCRIPTION

An example apparatus and method according to the present invention will now be described with reference to the accompanying Figures, in which:

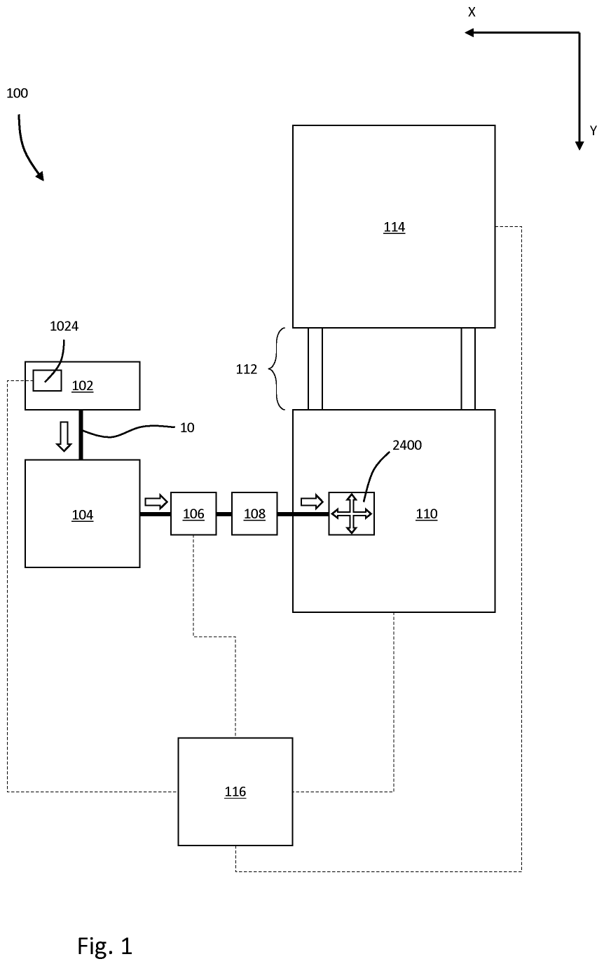

FIG. 1 is a schematic, plan view of an apparatus in accordance with the present invention;

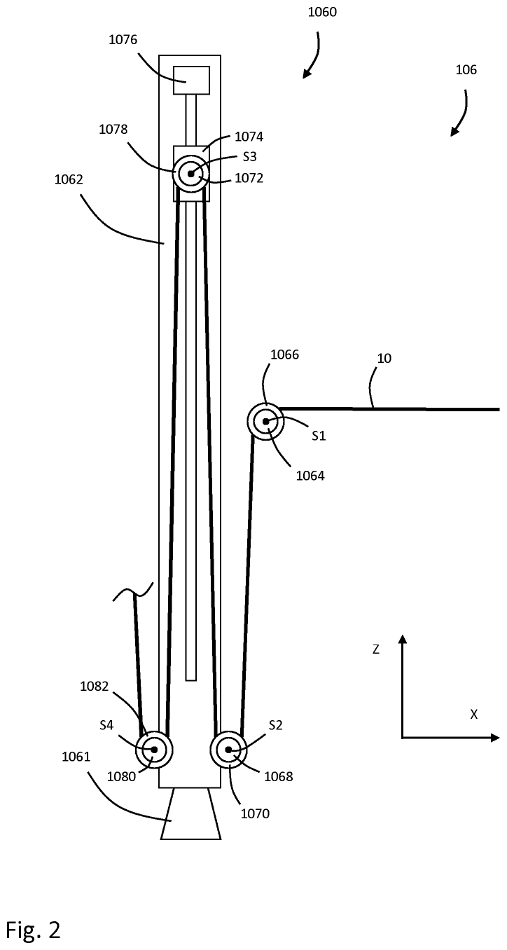

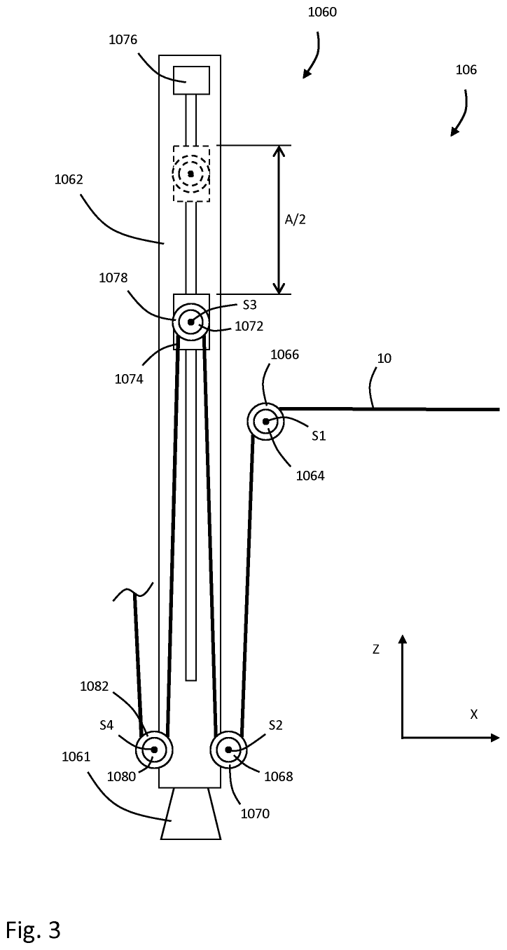

FIGS. 2 and 3 are a schematic, side views of an accumulator of the apparatus of FIG. 1;

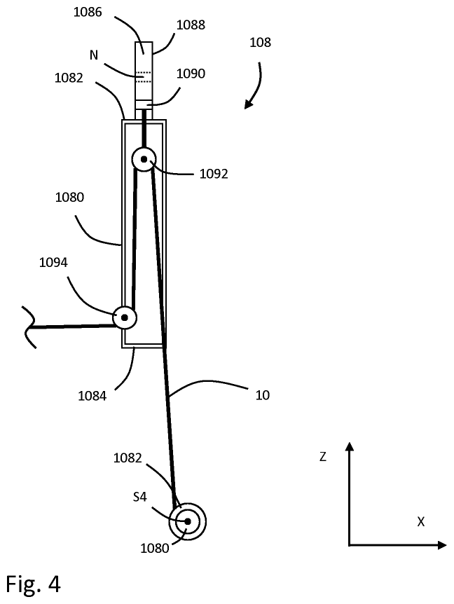

FIG. 4 is a schematic, side view of a compensator of the apparatus of FIG. 1;

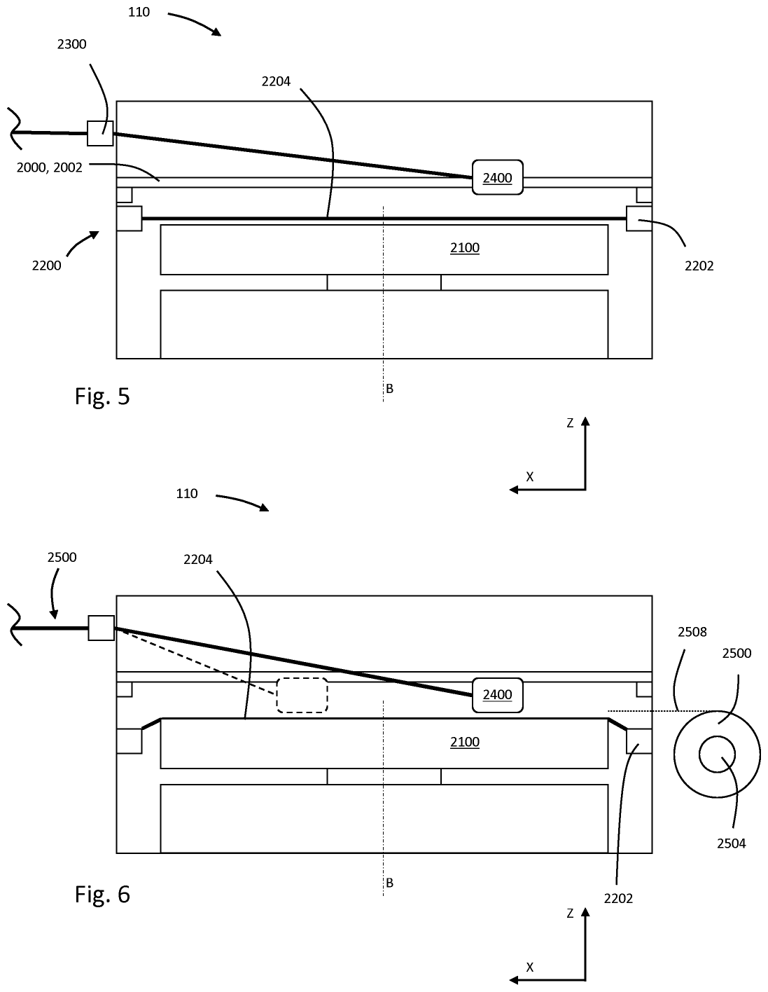

FIGS. 5 and 6 are schematic, side views of an automated fibre placement cell of the apparatus of FIG. 1;

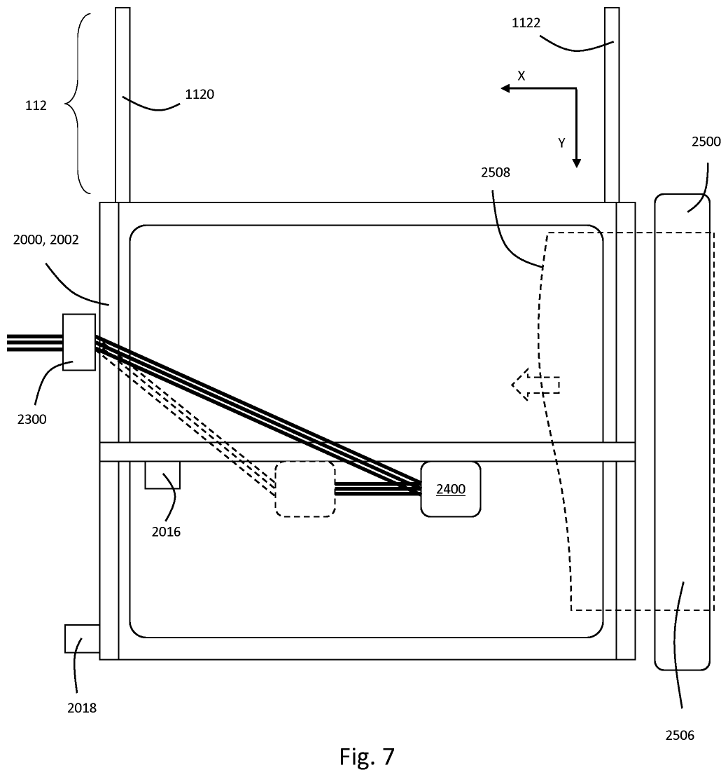

FIG. 7 is a schematic, plan view of the automated fibre placement cell of FIGS. 5 and 6;

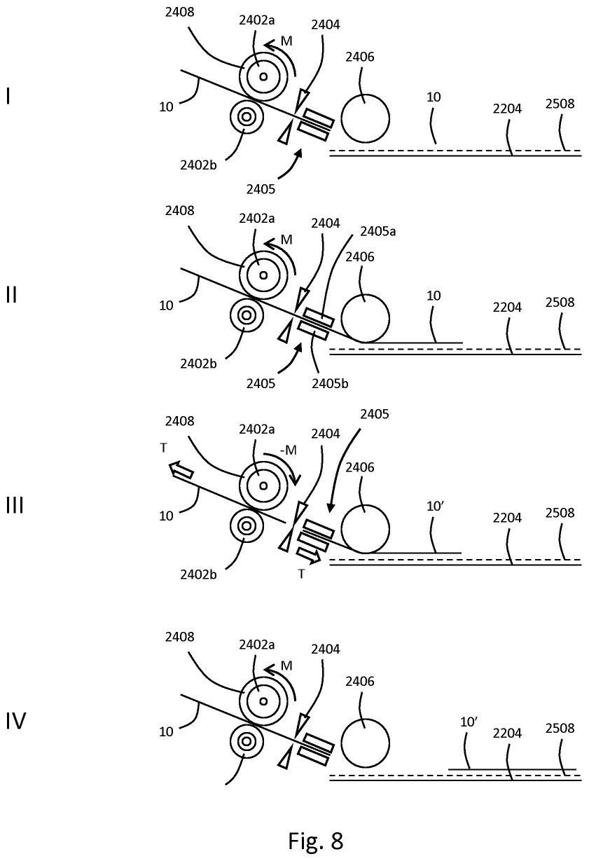

FIG. 8 is a schematic representation of several stages of operation of an AFP head of FIG. 1;

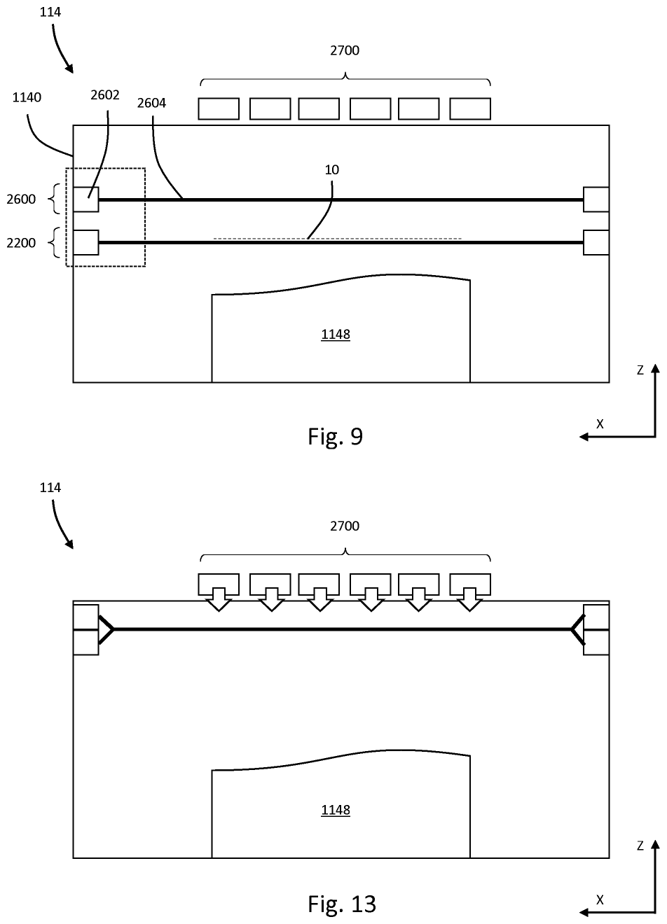

FIG. 9 is a schematic, side view of a diaphragm forming cell of the apparatus of FIG. 1;

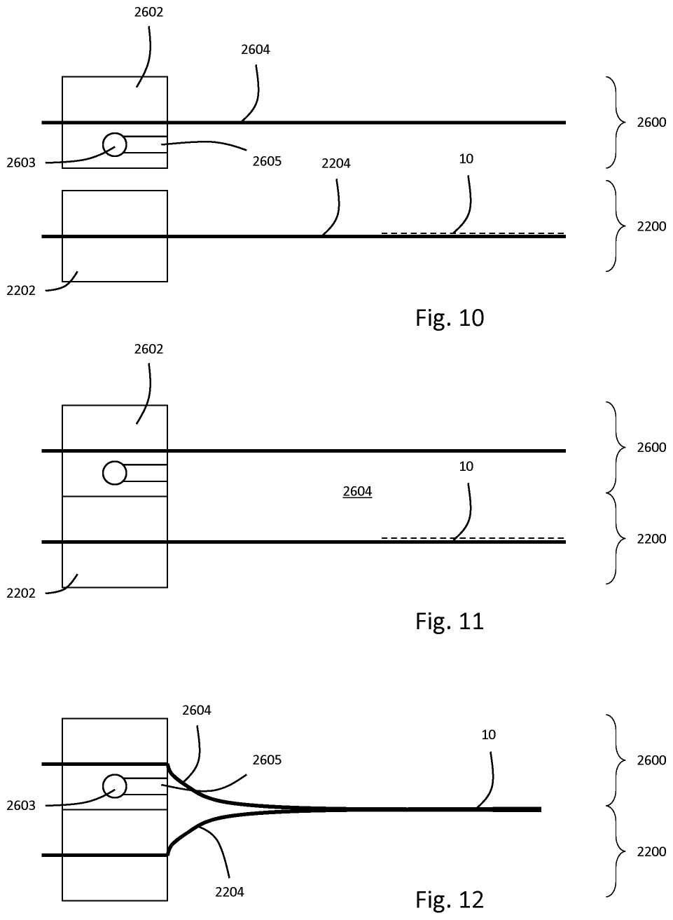

FIGS. 10 to 12 are schematic, side views of the steps of operation of the cell of FIG. 9;

FIG. 13 is a schematic, side view of the diaphragm forming cell of FIG. 9 in a different state of operation;

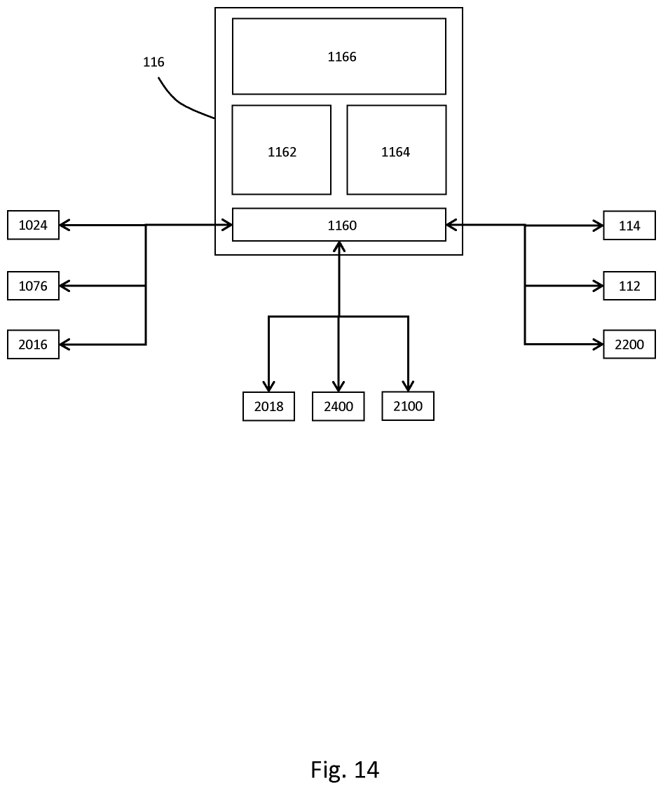

FIG. 14 is a schematic drawing of the control system of the apparatus of FIG. 1; and,

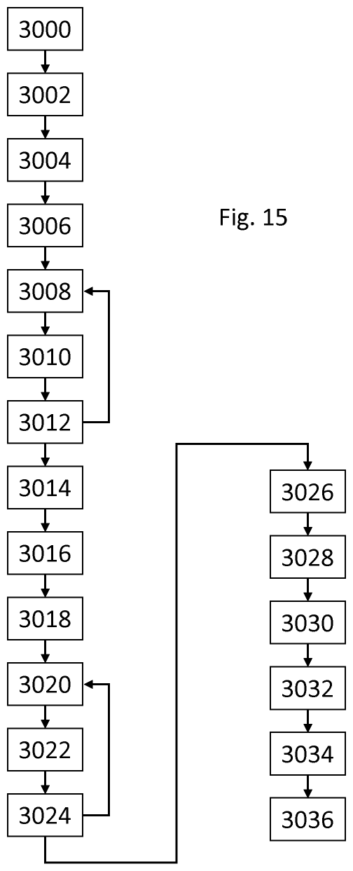

FIG. 15 is a flow diagram of a method of manufacture according to the present invention using the apparatus of FIG. 1.

Referring to FIG. 1, there is shown a manufacturing apparatus 100. The apparatus 100 is configured to receive bobbins of fibre tow and form the tow into a three dimensional preform suitable for resin transfer moulding (RTM). In order of process flow (as will be described below), the apparatus comprises the following sub-assemblies and stations in the process:
A fibre offwind 102;
A guide frame 104;
An accumulator 106;
A compensator 108;
An automated fibre placement cell 110 having an automated fibre placement (AFP) head 2400;
A conveyor 112;
A diaphragm forming cell 114; and,
A controller 116.

It will be understood that although each of the sub-assemblies works synergistically with the others to achieve the desired result, they can operate as independent modules as required. Each of the sub-assemblies will be described in detail below.

### Fibre Offwind 102

It will be understood that fibre offwind systems in general are known in the art. The fibre offwind 102 incorporated into the apparatus 100 comprises a frame on which a plurality (in this embodiment, eight) individual shafts are mounted for rotation about parallel axes driven by individual motors 1024. A bobbin is mounted on each shaft. Each bobbin comprises a length of wound carbon fibre tow 10. The tow comprises flat strips of carbon material formed from parallel fibres. In this embodiment, each bobbin 1028 comprises approximately 12 kg of wound carbon fibre tow. The tow used in the present embodiment is “dry”—that is to say that it is provided without a heat-responsive coating such as a powder binder.

The rotation of each shaft is influenced by a motor which has the ability to brake the shaft and thereby influence the tension in the fibre tow. The motors of the offwind are controlled by the controller 116.

At one side of the frame there is provided an exit feed which guides the tow from the bobbins towards the guide frame 104 as is wound off.

### Guide Frame 104

The guide frame 104 is positioned downstream of the offwind and receives tow therefrom. It is also upstream of the accumulator 106 (to be described below). Before feeding to the accumulator, it is desirable that the individual tows are aligned, co-planar and spaced apart by a predetermined distance. The primary purpose of the guide frame is to accept the tow from the off-wind (which will feed in to the guide frame 104 at varying positions) and to prepare it for the accumulator.

The guide frame 104 therefore comprises several sets of rollers and fairleads to guide the tow to the accumulator.

### Accumulator 106

Referring to FIGS. 2 and 3, the accumulator 106 comprises a frame 1060 which has a generally vertical member 1062. The frame 1060 is supported on the floor by a foot 1061. Even though the member 1062 is shown in the Figures in the vertical position, this member 1062 can also be horizontal or be in any other position therebetween.

An entry shaft 1064 having a horizontal axis S1 is mounted to the frame 1060 at a first vertical position. The entry shaft 1064 is fixed in the vertical sense. A plurality of sheaves 1066 are mounted for free rotation on the entry shaft 1064 via low friction roller bearings (not visible). In this embodiment, there are eight sheaves 1066 each having a shaft portion and opposed end flanges to retain a respective strip of tow 10 on the shaft portion.

A first fixed shaft 1068 having a horizontal axis S2 is mounted to the frame 1060 at a second vertical position. The first fixed shaft 1068 is fixed in the vertical sense. A plurality of sheaves 1070 are mounted for free rotation on the first fixed shaft 1068 via low friction roller bearings (not visible). In this embodiment, there are eight sheaves 1070 each having a shaft portion and opposed end flanges to retain a respective strip of tow on the shaft portion.

A displaceable shaft 1072 having a horizontal axis S3 is mounted to the frame 1060 for vertical movement. The displaceable shaft 1072 is supported on a carriage 1074 which is vertically displaceable via a linear actuator 1076. A plurality of sheaves 1078 are mounted for free rotation on the displaceable shaft 1072 via low friction roller bearings (not visible). In this embodiment, there are eight sheaves 1078 each having a shaft portion and opposed end flanges to retain a respective strip of tow on the shaft portion.

A second fixed shaft 1080 having a horizontal axis S4 is mounted to the frame 1060 at the same vertical position as the first fixed shaft 1068. The second fixed shaft 1080 is fixed in the vertical sense. A plurality of sheaves 1082 are mounted for free rotation on the second fixed shaft 1080 via low friction roller bearings (not visible). In this embodiment, there are eight sheaves 1082 each having a shaft portion and opposed end flanges to retain a respective strip of tow on the shaft portion.

The rows of sheaves 1066, 1070, 1078, 1082 are aligned in the axial sense. Each of the tow strips 10 from the guide frame 104 enters in direction −X. It is fed over a sheave 1066 on the entry shaft 1064, passing through 90 degrees to a downward direction −Z. Each tow is then fed under a sheave of the first fixed shaft 1068, turning through 180 degrees to direction Z before passing over a sheave of the displaceable shaft 1072 through 180 degrees to direction −Z to a sheave of the second fixed shaft 1080. The tow passes through another 180 degree turn back to +Z towards the compensator 108.

Therefore, the tow forms an inverted “U” shape in the XZ plane passing between the first fixed shaft 1068, the displaceable shaft 1072 and the second fixed shaft 1080.

The role of the accumulator is to keep tension substantially constant in the tow as the AFP head 2400 moves (to be described in more detail below). For the purposes of the present description, it will be understood that a non-negative (>0 Newton) tension should be retained in the tow 10 at all times. Because the AFP head moves (notwithstanding the deposition of tow from the head), tension would otherwise vary significantly. For example, if the AFP head moves towards the direction from which the tow is fed, the tension would quickly reduce, perhaps below zero (i.e. causing slack tow). Similarly, if the AFP head moves away from the direction from which the tow is fed, the tension would quickly increase, perhaps excessively.

Movement of the displaceable shaft 1072 in the vertical Z direction alters the length of tow between the first and second fixed shafts 1068, 1080.

In this way, control of the linear actuator 1076 can be used to account for movement of the AFP head 2400. If the AFP head moves away from the direction of feed of tow by a distance A, the linear actuator can be moved by A/2 towards the fixed shafts 1068, 1080 to take up the additional tow in the feed. This movement is demonstrated by comparing FIGS. 2 and 3.

In other words, the accumulator accumulates or takes up the slack in the system. Similarly, if the AFP head moves towards from the direction of feed of tow by a distance B, the linear actuator can be moved by B/2 towards the fixed shafts 1068, 1080 to provide additional tow in the feed. The linear actuator 1076 is controlled by the controller 116 as will be described below.

### Compensator 108

Referring to FIG. 4, the compensator 108 is shown.

The compensator 108 is downstream of the accumulator 106 and upstream of the AFP cell 110. Whereas the accumulator is configured to account for:
large variations in tow tension/displacement;
across all tows simultaneously,
   the compensator is configured to absorb:
smaller variations in tension/displacement;
for each individual tow.

The compensator 108 comprises a frame 1080. The frame 1080 has a first (upper) end 1082 and a second (lower) end 1084. A plurality of eight pneumatic springs 1086 are attached to the upper end of the frame, each spring 1086 comprising a cylinder 1088 and a piston 1090 linearly movable therein in the Z axis. It will be noted that in FIG. 4, on the end spring is visible, but eight are provided. Each piston 1090 is configured to have a neutral position N. Movement in either direction along the Z axis from the rest position provides a resilient force on the piston urging it towards the neutral position. A roller 1092 is mounted to the lower end of each piston. Similar to the member 1062, the compensator 108 can also be in a horizontal position or in any position between vertical and horizontal.

A plurality of eight sheaves 1094 are mounted on a single shaft for rotation proximate the second end 1084 of the frame 1080. Again, only the end sheave 1094 is visible.

In use, the tow 10 is passed upwardly (in the +Z direction) from the accumulator and over the rollers 1092. From there, the tow 10 is passed to the sheaves 1094 where it turns through approximately 90 degrees to travel in the −X direction towards the AFP cell 110.

The eight springs 1086 are independent—therefore each piston 1090 can move independently of the others. The result is that any increased tension in any individual tow 10 will act to pull the piston 1090 from the cylinder 1088. Therefore, these small variations in tension which occur between tows are absorbed to provide a near-constant positive tension (note that large variations common to all tows are dealt with by the accumulator). Similarly, any drops in tension which occur between tows are absorbed with the pistons travelling upwardly to maintain the near-constant positive tension.

### Automated Fibre Placement (AFP) Cell 110

A side view of the AFP cell 110 is shown in FIGS. 5 to 7.

The AFP cell comprises:
a gantry 2000;
a bed 2100;
a membrane assembly 2200;
a gate 2300;
an AFP head 2400; and,
a scrim feeder 2500

The gantry 2000 comprises a gantry frame 2002. In this embodiment, the gantry is approximately 2.0 m×2.0 m in plane. The gantry 2000 is configured to move the AFP head 2400 in the X, Y directions using a pair of motors 2016, 2018 respectively. The plane is shown in a horizontal position but it could be implemented in any desired plane (vertical, horizontal or any other angle).

The bed 2100 is attached to the gantry 2000, and is configured to rotate about an axis B which is parallel to Z.

The membrane assembly 2200 comprises a frame 2202 and a membrane 2204. The membrane is constructed from a sheet of deformable, elastic material (silicone in this embodiment). The frame 2202 holds the membrane 2204 under tension. The AFP cell comprises a plurality of actuators (not visible) which lower the membrane assembly 2200 onto the bed 2100. As the membrane is lowered, the bed 2100 fits within the frame 2202 to contact the membrane 2204 (FIG. 6). Therefore, when the membrane assembly is supported in the gantry by the bed 2100, the membrane 2204 rests on the bed 2100 to provide a planar reaction surface for the deposition of fibre by the AFP head 2400. The bed 2100 can also rotate the membrane assembly 2200 about the axis B via an electric motor (not shown). The gate receives the tow 10 from the compensator 108 and feeds it directly to the AFP head 2400. Only three strips of tow are shown in FIG. 7 for simplicity.

A binder feeder in the form of a scrim feeder 2500 is provided as shown in FIG. 5. The scrim feeder 2500 comprises a shaft 2504 outside but adjacent the gantry 2000. The shaft 2504 is parallel to the side of the gantry 2000 and holds a roll 2506 of sheet thermoplastic, net-like scrim material 2508. The binder material in the form of the scrim material 2508 can be pulled from the roll (manually or automatically), across the upper surface of the membrane 2204 to cover it. The AFP head 2400 then deposits directly onto the scrim 2508. Use of the scrim material 2508 is discussed further below.

The AFP head 2400 receives the 8 strips of tow 10 from the gate 2300 and is configured to deposit them onto the membrane 2204 (specifically onto a layer of scrim 2508 which overlays the previous fibre layer). The tow is fed in the −X direction from the gate 2300 and enters the head 2400. The tow 10 exits the AFP head 2400 at the membrane 2204, parallel to the direction of entry (i.e. −X).

FIG. 8 shows the stages of operation within the AFP head 2400 in schematic form. The AFP head comprises a pair of opposed nip rollers 2402a, 2402b, a cutter 2404, a heater channel 2405 and a deposition roller 2406. The nip roller 2402a is driven by a motor 2408 which is connected to the roller 2402a by a sprag clutch. The heater channel 2405 comprises heaters 2405a, 2405b which are arranged to heat the tow 10 passing therethrough by conduction. In this embodiment, the heaters 2405a, 2405b are resistive.

Step I in FIG. 6c shows the feed condition. The motor 2408 is driven in direction M to pull the tow 10 into the head 2400 and guide it towards the deposition roller 2406. The sprag clutch engages when the motor is driven in direction M to drive the roller 2402a in the same direction.

Moving to step II, the tow is “grabbed” by the deposition roller (i.e. between the deposition roller and the membrane 2204) which effectively becomes the master drive for the tow feed. The deposition roller is not directly driven—instead it rotates under friction as the head is moved across the membrane with the deposition roller 2406 in contact with the tow, which in turn is in contact with the membrane, scrim or previous layer of tow. As the tow is now being pulled, the nip roller 2402a can freewheel in direction M relative to the motor 2408. The motor 2408 is driven at a slower speed than the deposition roller 2406 to ensure that the sprag clutch can freewheel. Before the tow contacts the membrane 2204, and upstream of the deposition roller 2406, it is heated as it passes through the heater channel 2405. The power delivered to the heaters 2405a, 2405b is selected such that the temperature of the tow as it is deposited is sufficient to slightly melt (i.e. tackify) the scrim 2508. As the AFP head moves across the membrane 2204, the tackified scrim “grabs” the tow. The tow is under a tension force T as it is deposited. It will be noted that this method is well suited to “dry” tow being applied to a scrim.

Moving to step III, after a strip of tow 10 has been deposited, the cutter 2404 is activated to cut the tow 10. The downstream tow 10 continues to be deposited by the roller 2406 because of this the cutter must move at the same rate as the tow, whilst the cut is being made. It is undesirable to continuously feed the tow 10 after the cut is made and the cutter is returning to its starting position, as it would bunch up behind the cutter 2404. As the upstream tow 10 under tension T (previously reacted by the off-wind, accumulator, compensator etc.) is drawn back through the nip rollers 2402a, 2402b, the sprag clutch engages. As such, progress of the tow 10 back through the nip rollers 2402a, 2402b can be controlled by the motor 2408. The motor 2408 is powered in direction −M to controllably drive the cut tow feed 10 away from the cutter 2404. In this way, tension can be maintained (the motor 2408 effectively acts as a brake on the tensioned tow).

Once the tow 10′ has been deposited, and the cutter 2404 disengaged, the motor 2408 can be used to feed the tow 10 back to the deposition roller 2406. This is shown in step IV. The cycle can then be repeated for a new strip.

Operation of the AFP head 2400 in context will be described below as part of the operation of the assembly 100.

### Conveyor 112

With reference to FIGS. 1 and 7, the conveyor 112 comprises two parallel rails 1120, 1122 extending in the Y direction and spaced apart in the X direction. The rails 1120, 1122 support rolling elements on the underside of the membrane assembly frame 2202 and allow it to be moved from the AFP cell 110 to the diaphragm forming cell 114 in direction −Y.

### Diaphragm Forming Cell 114

The diaphragm forming cell 114 is separate to, and downstream of, the AFP cell 110. The diaphragm forming cell 114, shown in FIG. 9 from the side, comprises a frame 1140 being approximately the same shape and size as the AFP cell 110 (it also receives the membrane assembly 2200).

The diaphragm forming cell 114 comprises a further membrane assembly 2600. The further membrane assembly 2600 is similar in form to the membrane assembly 2200. It comprises a frame 2602 and a membrane 2604. The frame 2602 defines fluid channels 2603 (FIG. 10) in communication with the lower side of the membrane 2604 via ports 2605. The channels 2603 are connected to a vacuum pump (not shown).

The diaphragm forming cell 114 comprises a male mould form 1148 positioned underneath the membrane 2204.

The diaphragm forming cell 114 comprises a heater 2700 configured to direct radiant heat onto the membranes 2204, 2604 from above.

Both the membrane assembly 2200 and the further membrane assembly 2600 can be moved in the ±Z direction in use. FIGS. 10 to 12 show how the cell 114 can clamp the deposited fibre for forming.

In FIG. 10, the deposited fibre 10 is shown resting on the membrane 2204 with the membrane 2604 directly above. The further membrane assembly 2600 is lowered until a seal is created between the respective frames 2202, 2602 (FIG. 11). At this point a closed cavity 2604 is created containing the deposited fibre 10.

In FIG. 12, a vacuum is drawn through the channels 2603 to evacuate the cavity 2604 of air (or at least significantly lower the pressure therein). The cavity reduces in size until the membranes 2204, 2604 clamp the deposited fibre 10.

Turning to FIG. 13, frames 2202, 2602 are then be raised to the heater 2700 to heat and thereby soften the scrim. Raising the temperature acts to tackify the scrim 2508 and hold the layers of tow 10 together between the membranes 2204, 2604.

The frames 2202, 2602 are then lowered onto the male mould form 1148 to deform the membranes 2204, 2604 and the fibre and tackified scrim held therebetween into the desired 3D shape.

### Controller 116

The controller 116 is shown schematically in FIG. 14. It comprises an input/output module (I/O) 1160, a processor 1162, a memory 1164 and a human-machine interface (HMI) 1166. The controller is configured to process a program stored on the memory 1164 using the processor 1162. It can receive instructions and display information on the HMI 1166, and receive and send data to the various subassemblies in the apparatus 100 via the I/O module 1160.

In particular, the I/O module has two-way data links to:
the off-wind motors 1024;
the linear actuator 1076 of the accumulator;
the X-Y motors 2016, 2018 controlling the position of the AFP head;
the AFP head 2400 itself;
the motor controlling rotation of the bed 2100;
the actuators controlling the Z position of the membrane assembly 2200 within the AFP cell;
the actuators of the conveyor 112; and,
the diaphragm forming cell—specifically:
   the heaters 2700;
   the actuators controlling movement of the membrane assembly 2200 and the further membrane assembly 2600; and,
   the vacuum pump.

### Process Description

In terms of the forming process, the apparatus functions as follows, with reference to FIG. 15.

At step 3000, the process is initiated in which a 2D shape is generated from a desired 3D preform. This process will not be described in detail here, but it will be understood that such techniques are known in the art.

At step 3002, the 2D shape is split into “strips” representing lines of tow required to make the shape. Typically, a plurality of layers is also generated with strips in different directions depending on the requirement of the final part (for example, there may be 4 layers—0 degrees/90 degrees/0 degrees/90 degrees).

At step 3004, the apparatus 100 is initiated. In this state, the membrane 2204 is lowered onto the bed 2100.

At step 3006, the AFP head 2400 is moved into a starting position for the first layer of tow 10 using the gantry motors 2016, 2018. As it does so, the resulting feed through the gate 2300 is taken up by the accumulator. The controller 116 is configured to generate a level of accumulation required by the XY movement of the head 2400, and the accumulator actuator 1076 is adjusted to provide this accumulation. For example, if the head 2400 moves towards the gate 2300, the actuator 1076 moves the shaft 1072 upwards. If the head 2400 moves away from the gate 2300, the actuator 1076 moves the shaft 1072 downwards. It will be noted that the position of the shaft 1072 is entirely dependent on the XY position of the head 2400 such that as far as the offwind is concerned, the head 2400 is not moving.

At step 3008, the AFP head is engaged and tow 10 is deposited onto the membrane 2204 supported by the bed 2100 in a strip. The off-wind 102 allows tow 10 to be wound from the bobbins 1028, but the controller uses the motors 1024 to retain a tension in the tow 10 as this occurs. The controller 116 therefore simultaneously controls the off-wind 112 and the accumulator 106 to retain tension in the tow 10.

At step 3010, the tow 10 is cut (the strip is finished).

At step 3012, the head 2400 is moved to the starting position for the next strip, and step 3008 is repeated.

Once all the strips in the first layer have been deposited, at step 3014 a layer of scrim 2508 is pulled across the first layer of tow.

At step 3016, the bed 2100 is rotated by the controller 116 by 90 degrees for deposition of the next layer of tow. It will be noted that the head 2400 can only deposit tow in one direction, and as such rotation of the bed 2100 is necessary for layers having different orientations.

At step 3018, the AFP head 2400 is moved into a starting position for the second layer of tow 10 using the gantry motors 2016, 2018. As it does so, the resulting feed through the gate 2300 is taken-up by the accumulator.

At step 3020, the AFP head is engaged and tow 10 is deposited onto the scrim 2018 supported by the bed 2100 in a strip. The off-wind 102 allows tow 10 to be wound from the bobbins 1028, but the controller uses the motors 1024 to retain a tension in the tow 10 as this occurs. The controller 116 therefore simultaneously controls the off-wind 112 and the accumulator 106 to retain tension in the tow 10.

At step 3022, the tow 10 is cut (the strip is finished).

At step 3024, the head 2400 is moved to the starting position for the next strip, and step 3020 is repeated.

Once all the strips in the first layer have been deposited, at step 3026 a further layer of scrim 2508 is pulled across the first layer of tow, and so on until all layers have been deposited.

The result is a 2D multiaxial fabric preform constructed from alternating layers of unidirectional fibres.

It will be noted that throughout this process, the compensator 108 is “smoothing out” high frequency variations in the individual tow tension.

At step 3028, the membrane assembly 2200 is raised off the bed 2100 and moved by the conveyor 112 to the forming cell 114.

Once in the forming cell, at step 3030 the further membrane assembly 2600 is lowered onto the membrane assembly 2200 and a vacuum generated to draw the membranes 2204, 2604 together to sandwich the deposited tow and scrim therebetween.

The membranes are raised and heated in step 3032 (as described above), and lowered in the −Z direction at step 3034, to deform the membranes and thereby the deposited tow 10.

At step 3036, the vacuum is released to expose the pre-form, which due to the scrim will retain its shape for a further resin transfer moulding operation. The scrim also aids permeability of the preform for resin impregnation.

### Variations

The following variations on the above embodiment fall within the scope of the claims.

The functions of the accumulator and/or compensator may be fulfilled by the off-wind sub-assembly. If a suitably sized motor was provided which had a significant torque and a fast response time, then the need for a separate accumulator and/or compensator could be eliminated, although this would require modification to the controller.

The membrane need not be 2D upon initial deposition. Although it is easier to control an AFP head in only two dimensions, it is within the scope of this invention to deposit the fibre onto the membrane in a first 3D shape in the AFP cell, and deform to a second 3D shape in the diaphragm forming cell.

A powder deposition means may be provided within the guide frame 140 to provide the fibre tows with e.g. binder powder which may supplement, or replace, the function of the scrim. The powder deposition means may be assembled with the AFP head for powder deposition immediately following tow deposition.

Alternatively, there may be an intermediate powder deposition stage between tow deposition and moulding. In this embodiment, a layer of powder tow may be deposited on the top layer of tow. Alternatively, each layer could be powdered after deposition.

The resin transfer process may be carried out in the forming cell.

There are thus provided methods and apparatus for manufacturing preforms including any preforms manufactured by the aforesaid methods and apparatus.

1-93. (canceled)

94. A method of manufacture of a preform for a composite moulding operation, comprising the steps of:
providing a preform having deformable surface in a first shape;
providing a fibre placement head;
depositing a fibre onto the deformable surface of the preform, said deformable surface being a flexible membrane in a first shape;
moving at least one of the fibre placement head and deformable surface relative to one another whilst depositing the fibre from the head onto the deformable surface to form the preform in the first shape; and
deforming the deformable surface, whereby the preform is formed into a second shape, different to the first shape.

95. The method according to claim 94, in which the deformable surface is rotationally moveable about an axis intersecting the deformable surface relative to the head.

96. The method according to claim 95, comprising the step of:
depositing two or more layers of fibre onto the deformable surface.

97. The method according to claim 96, further comprising the steps of:
providing a material configured to bind adjacent layers of fibre material;
applying the material to the fibre.

98. The method according to claim 97, wherein the binder material is a resin.

99. The method according to claim 98, wherein the binder material is in the form of a resin film or resin layer and the fibre is bound by resin tack.

100. The method according to claim 99, in which the binder material is applied to the fibre after it is deposited onto the flexible surface.

101. The method according to claim 100, further comprising the steps of:
applying the binder material between at least two of two or more layers of fibres.

102. The method according to claim 101, in which the binder material is in the form of a sheet.

103. The method according to any claim 102, further comprising the step of:
controlling the tack of the binder material by regulating the temperature of the binder material.

104. The method according to claim 103, in which the deformable surface is a flexible membrane.

105. The method according to claim 104, further comprising the steps of:
providing a second deformable surface;
after the step of depositing the fibre, enclosing the deposited fibre between the deformable surface and the further deformable surface to form a fibre cavity;
deforming the fibre to form a 3D preform by deforming the deformable surface and the further deformable surface.

106. The method according to claim 105, further comprising the steps of:
providing a fibre deposition cell at which the step of depositing the fibre takes place;
providing a separate forming cell at which the step of deforming takes place;
conveying the deformable surface between the fibre deposition cell and the forming cell.

107. An apparatus for the manufacture of a fibre preform for a composite moulding operation, the apparatus comprising:
a fibre placement head;
a deformable form;
a three-dimensional mould shape;
in which at least one of the fibre placement head and deformable surface is moveable to deposit fibres onto the deformable surface to form a preform in a first shape; and,
in which at least one of the deformable surface and three-dimensional mould form is movable relative to the other such that the preform in the first shape on the deformable surface is deformed into a second shape different to the first shape.
